(19) United States
(12) Patent Application Publication
(10) Pub. No.: US 2009/0006115 A1
(43) Pub. Date: Jan. 1, 2009

(54) Establishing and updating reputation scores in online participatory systems

(75) Inventor: Michael Schwarz, Berkeley, CA (US)

Correspondence Address: YAHOO C/O MOFO PALO ALTO, 755 PAGE MILL ROAD, PALO ALTO, CA, 94304, US

(73) Assignee: Yahoo! Inc., Sunnyvale, CA (US)

(21) Appl. No.: 11/824,552

(22) Filed: Jun. 29, 2007

(51) Int. Cl. G06Q 10/00; G06F 17/40

(52) U.S. Cl. 705/1

(57) ABSTRACT

The establishment and adjustment of the reputation score of a party in an online transaction system is described. A party may provide consideration to a transaction portal. In response, the transaction portal may increase (or initially establish) a reputation score for the party based upon the consideration. The portal may return to the party at least a portion of the consideration in response to a favorable event. The portal may decrease the score based upon factors such as the value of transactions weighted by user ratings. The transaction portal may also increase the score based upon a function of commissions made in transactions involving the party.

### BACKGROUND

Trust is an important element for users dealing with each other in the online marketplace. As an indicator of trust, Internet transaction sites, such as auction houses, provide users with seller and buyer reputation scores. Reputation scores provide useful information to the user in deciding whether to enter into a transaction. User ratings of prior transactions with the seller or buyer typically determine the reputation score.

One problem with conventional reputation systems is that new participants start with a reputation score of zero. This makes it difficult for them to join the marketplace, especially as sellers. Moreover, after a seller has established a reputation with one online market, it is difficult for the seller to switch to another market because the seller has to establish reputation again in the new market, resulting in “stickiness.”

Second, an unscrupulous seller may manipulate existing reputation systems. For example, eBay computes reputation score as the difference between the number of positive and negative ratings received by a buyer (or seller). A seller can develop a high reputation score by creating a large number of small (possibly fictitious) transactions. Then the seller can use the high score to sell one very high value item, take payment and not ship the item. In fact, there is a “market for feedback” in which sellers can “buy reputation” to increase their score. See J. Brown, et al., “Reputation in Online Auctions: The Market for Trust,” California Management Review, Vol. 49, No. 1 (Fall 2006), pp. 61-81 (“Brown” ). Brown suggests, as one solution, offering transaction-weighted reputation statistics based on the dollar value of the trade, rather than the current practice where the sale of high and low value items have the same reputational effect. Brown, at 18. Brown, however, does not provide further details as to implementation.

It is desired to develop improved techniques for establishing and updating reputation in online markets.

### BRIEF SUMMARY

Embodiments of the invention provide for the establishment and adjustment of the reputation score of a party in a transactional system. A party may provide consideration to a transaction portal. In response, the transaction portal may increase (or initially establish) a reputation score for the party based upon the consideration. The portal may require a minimum reputation score as a condition for participation in the transaction system. The portal may provide the score for display on the client computers of other users of the system, so that those users can decide whether to transact business with the party based upon the party's reputation score.

The portal may return to the party at least a portion of the consideration in response to a favorable event, such as the score exceeding a threshold after a predetermined period of ti-me, the party receiving less than a predetermined number of negative user ratings over a period of time, or the party receiving at least a predetermined number of positive user ratings over a period of time.

The portal may adjust the the score based upon user ratings of transactions, and, in particular, upon the value of each transaction weighted by a user rating of the transaction.

By using a transaction system implementing the above approach, a new entrant to the system may immediately establish a reputation. This overcomes the problem of “stickiness” in conventional systems.

The same principles may be applied to allowing user participation in social networks and other online activities based upon establishment and maintenance of a reputation score. In those embodiments, the transaction portal may return to the user, in response to a favorable event, at least a portion of the consideration used to establish an initial reputation.

In some embodiments, the transaction portal may increase the score based upon a non-decreasing function of commissions made in transactions involving the party. The transaction portal may also adjust the score based upon other attributes of transactions such as value of the transaction, user rating of the transaction, and reputation of the user providing a rating of the transaction. For example, the portal may determine the score based upon (a non-decreasing function of commissions paid by the party as seller) and (the value of sales conducted by the party weighted by user ratings).

### BRIEF DESCRIPTION OF THE DRAWINGS

FIG. 1 illustrates a computer network environment according to embodiments of the invention.

FIG. 2 illustrates a computing system that may be employed to implement processing functionality in embodiments of the invention.

### DETAILED DESCRIPTION

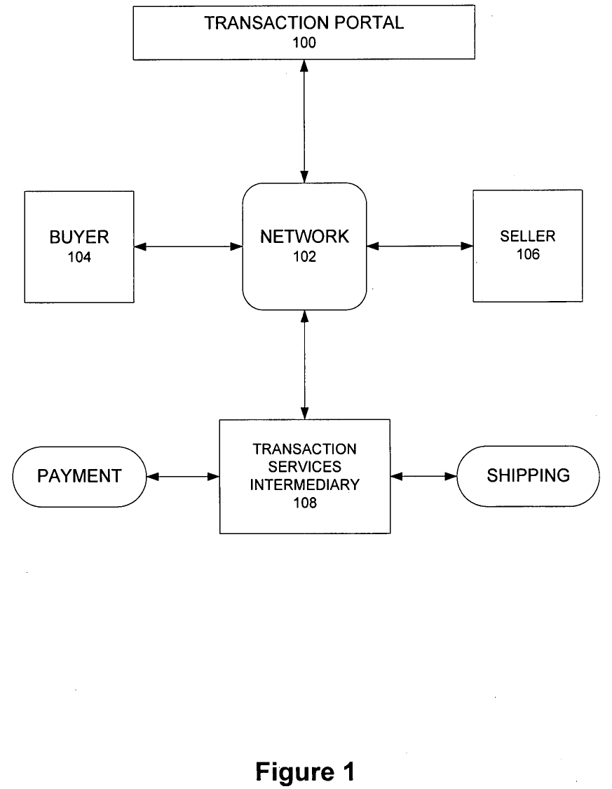

FIG. 1 illustrates a computer network environment according to embodiments of the invention. The network environment includes an online transaction portal 100 (e.g., a server) coupled through a communications network 102, such as the Internet, to buyer and seller client computers 104 and 106, respectively. The transaction portal may coordinate electronic commerce between a buyer and a seller in the context of a transaction such as an auction, classified advertisement, or the like. The transaction portal 100 is also coupled, either directly or through the Internet (as shown), to a transaction services intermediary 108 for coordinating fulfillment of transactions implemented at the transaction portal 100. The transaction services intermediary may handle payment processing and shipping, for example. The above-recited elements provide the means for implementing the functionality of the embodiments of the invention described herein.

According to embodiments of the invention, a party, denoted for convenience here as a “primary party,” may establish a reputation score (or increase an existing reputation score) by providing consideration to the transaction portal 100 (i.e., the transaction portal facilitates the transfer of consideration to an entity designated to receive the consideration). The primary party may be a buyer or a seller. In this manner, the primary party effectively “buys” reputation to establish trust with other parties to a transaction. The consideration may take the form of an online payment, a credit toward commissions on future trades, or the like. In some embodiments, the transaction portal 100 may require consideration as a condition for the party's participation in transactions through the portal 100.

In some embodiments, the transaction portal 100 may treat the consideration as non-refundable, or refund all or part of the consideration based upon one or a combination of favorable conditions, such as, for example, the party's reputation score exceeding a threshold score after the passage of a given length of time, the passage of a given length of time itself, the receipt of at least a given number of positive user ratings from other parties dealing with the party over a given period of time, the receipt of fewer than a given number of negative user ratings over a given period of time, or the like. (As an example, a “positive” user rating may exceed or equal a rating threshold of 0.5, whereas a “negative” user rating may fall below the rating threshold of 0.5 on a scale of 0 to 1, where 0 represents complete dissatisfaction and 1 complete satisfaction with a transaction.) The transaction portal 100 may provide the refund automatically, or upon request of the primary party. The transaction portal 100 may reduce the reputation score by a value representing all or a portion of the returned consideration.

In response to receipt of the consideration, the transaction portal 100 may increase the score by all or a portion of the amount of the consideration. The transaction portal 100 may provide, over the communications network, the primary party's reputation score for display on other parties' client computers. The user at a client computer can then decide whether to participate in a transaction based upon the reputation score. In some embodiments, the portal 100 may provide the score only upon satisfaction of a condition, such as the score exceeding a predetermined value. By allowing a user new to the transaction portal 100 to establish a reputation, embodiments of the invention avoid the stickiness problem that hinders user movement in conventional systems.

Whether or not reputation is established in the above manner, the transaction portal 100 may adjust the reputation score based upon user ratings. The transaction portal 100 may display on the client computer “+” and “−” buttons on the screen for the user to enter respective positive or negative ratings of the transaction with the primary party, for example. In one embodiment, these inputs may be translated into discrete values respectively falling above and below a rating threshold, such as 0.5 on a scale of 0 to 1, for example.

In some embodiments, where consideration has been provided, the transaction portal 100 may decrease the score based upon a user rating of a transaction. (And, as discussed below, in some embodiments, the transaction portal 100 may also increase the score based upon commissions for the transaction.) In addition or as an alternative to employing the value of a user rating, the transaction portal 100 may decrease the reputation score based upon the number of negative ratings, from unique users, of transactions by the primary party. In some embodiments, the transaction portal 100 may require a threshold number of negative ratings from unique users to arise before decreasing the score.

As another aspect of embodiments of the invention, the transaction portal 100 may increase reputation score based upon commissions paid to the transaction portal 100 by the primary party. For example, the transaction portal 100 may apply a linear or nonlinear operator (such as square root) to the commission for each sale to give greater weight to smaller sales, based upon the assumption that a seller is less likely to build reputation with many fraudulent small sales than with a few large sales. The transaction portal 100 may compute the commission itself based upon the value of sales transactions by the primary party. For example, the transaction portal 100 may compute the commission as a percentage of sales. Note that, except where otherwise indicated, the reputation score to which adjustments are made may, or may not, have been established or increased by the deposit of consideration.

More comprehensively, the transaction portal 100.may compute the reputation score based upon a function of attributes of the transaction, including a user rating of the transaction, according to the recursive equation

Sᵢ₊₁=Sᵢ+Q(Aᵢ)

where Q is non-decreasing function, and Aᵢ represents one or more attributes of the i-th transaction, such as, for example, the value of the transaction, the commission, a user rating of the transaction, and a reputation of the user who rated the transaction. The transaction portal 100 may update the primary party's reputation score after a new transaction occurs and is rated, for example. The reputation of the user who rated the transaction may be based upon the principles described herein, or any other reputation scoring technique.

More particularly, the transaction portal 100 may compute the reputation score based upon a function of the commission less the value of each transaction weighted by a user rating for that transaction. This may be represented, for example, by the following equation:

Sᵢ₊₁=Sᵢ+[f(cᵢ)−xᵢ(1−rᵢ)]

where f(cᵢ) is a non-decreasing function of the commission cᵢ paid by the primary party as a seller (and/or, in some embodiments, the commission paid by the seller in which the primary party is a buyer), xᵢ is the value of the i-th transaction, and rᵢ is a user rating of the i-th transaction, which may range from 0 to 1 for lowest to highest user ratings, for example. In this example, i may range over all transactions or a predetermined number of the most recent transactions, for example.

This algorithm may be further limited to account only for instances where the primary party is a seller, by letting i range only over all sales (but not purchases) or a predetermined number of the most recent sales, for example.

As an example of the effect of one transaction on the above equation, assume that a new seller at the transaction portal 100 deposits consideration of $100 to establish a reputation score of 100. Assume that, the first transaction is valued at $100, the commission is 10% or $10, and that an unsatisfied buyer gives the transaction a rating of 0.1 on a scale of 0 to 1 (or a rating normalized to that value), with zero again representing complete dissatisfaction, and 1 full satisfaction.

The transaction portal 100 may increase the score by the value of the commission (10) and decrease the score by the value of the transaction weighted by the user rating, e.g., by x(1−r)=100(1−0.1)=90, resulting in a score of 100+10−90=20, where x is the value of the transaction, and r is the user rating. The resulting score of 20 would damage the seller's reputation, making it difficult to attract buyers for items valued more than $20 in the future. That is, in some embodiments, such a reputation score would represent that the seller would, at most, forfeit $20 for a fraudulent transaction, where the $20 would otherwise be available for a refund to the primary party.

To account for the reputation of the user uᵢ who provided the rating rᵢ, rᵢ may be represented, for example, by a function rᵢ(S(uᵢ)) of the reputation score S of the user uᵢ, so that, for example, rᵢ(S(uᵢ)) (falling between 0 and 1) gives increasing weight to the user's rating rᵢ depending upon the user's reputation score.

As another example, instead of accounting for the value of the rating, the score may more simply be decreased based just upon the transactions receiving negative user ratings.

Sᵢ₊₁=Sᵢ+[f(cᵢ)−x³¹ ᵢ]

where x⁻ᵢ represents the value of the i-th negatively rated transaction receiving a negative user rating. This method can be simplified further by accounting only for negatively rated sales transactions instead of all (buy and sell) transactions. In these examples, i may range over all negatively-rated transactions or a predetermined number of the most recent negatively-rated transactions, for example.

The transaction portal 100 may compute reputation score by also accounting for the number of transactions, e.g., as a sum of non-decreasing functions of the commission plus a non-decreasing function of the total number of transactions (including buy and sell transactions) minus the total value of transactions receiving negative feedback, as follows:

Sᵢ₊₁=Sᵢ+[f(cᵢ)−x⁻ᵢ]+g(T)

where x⁻ᵢ is a transaction that received a negative user rating, and g(T) is a non-decreasing function of the total number T of transactions x. For example, g(T) may simply represent T multiplied by a positive constant, with f and g selected to normalize S to fall within a desired score range.

In the embodiments herein, the transaction portal I 00 may employ a function of the commission f(cᵢ) that depends upon the consideration provided by the party. For example, the transaction portal 100 may use the consideration effectively as an “account” from which the commission for each transaction may be withdrawn as payment for the party's participation in a transaction. In the above equations, the transaction portal 100 may set f(cᵢ)=0 until after the account falls to less than or equal to an account threshold (e.g., 0), after which time the transaction portal 100 will allow f(cᵢ) to take on non-zero values when the party is again required to pay a commission from outside the prepaid account.

The above techniques may be applied outside the context of buying and selling goods or services. Reputation computed using the above methods may be used to allow participation in an online participatory activity, such as an online social network. For example, the transaction portal 100 may allow a party to participate in the activity only if the party's reputation score exceeds a score threshold.

Similar to the systems described above, the transaction portal 100 may enable a party to increase or establish a reputation score based upon the receipt of consideration from the party. Similar to the above-described embodiments, the transaction portal 100 may adjust the party's score based upon a user rating of the party's participation in the activity. For an online participatory activity, the transaction portal 100 may decrease the score by at least a portion of the consideration in response to a negative user rating, or by the consideration weighted by a user rating. Note that, for example, a user may give the party a negative rating if the user finds the party's participation in an online social network to be offensive.

Similarly, the transaction portal 100 may cause at least a portion of the consideration to be returned to the party in response to a favorable event, such as one or more of those described above.

While the invention has been described in terms of particular embodiments and illustrative figures, those of ordinary skill in the art will recognize that the invention is not limited to the embodiments or figures described. Those skilled in the art will recognize that the operations of the various embodiments may be implemented using hardware, software, firmware, or combinations thereof, as appropriate. For example, some processes can be carried out using processors or other digital circuitry under the control of software, firmware, or hard-wired logic. (The term “logic” herein refers to fixed hardware, programmable logic and/or an appropriate combination thereof, as would be recognized by one skilled in the art to carry out the recited functions.) Software and firmware can be stored on computer-readable media. Some other processes can be implemented using analog circuitry, as is well known to one of ordinary skill in the art. Additionally, memory or other storage, as well as communication components, may be employed in embodiments of the invention.

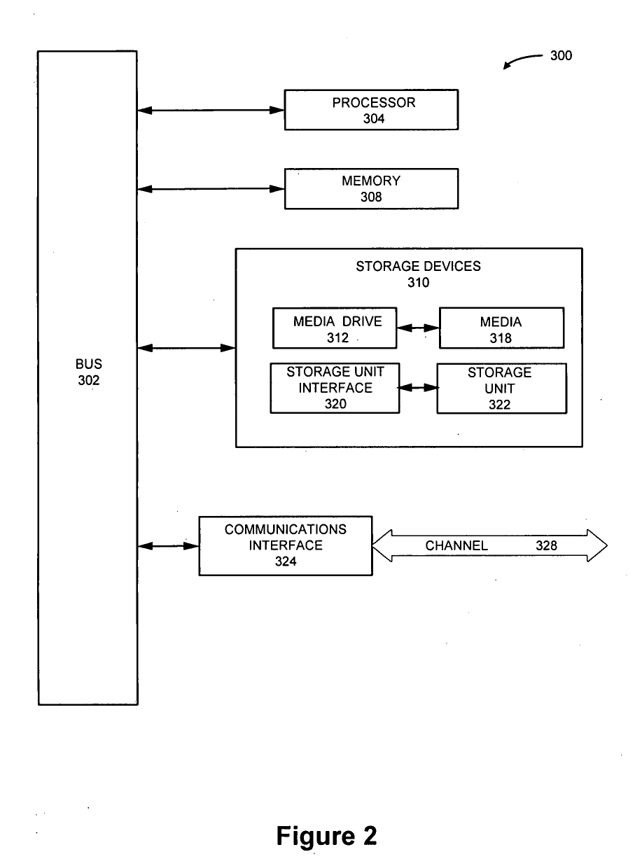

FIG. 2 illustrates a typical computing system 300 that may be employed to implement processing functionality in embodiments of the invention. Computing systems of this type may be used to implement the transaction portal, the buyer and seller client computers, and the transaction services intermediary, for example. Those skilled in the relevant art will also recognize how to implement the invention using other computer systems or architectures. Computing system 300 may represent, for example, a desktop, laptop or notebook computer, hand-held computing device (PDA, cell phone, palmtop, etc.), mainframe, server, client, or any other type of special or general purpose computing device as may be desirable or appropriate for a given application or environment. Computing system 300 can include one or more processors, such as a processor 304. Processor 304 can be implemented using a general or special purpose processing engine such as, for example, a microprocessor, microcontroller or other control logic. In this example, processor 304 is connected to a bus 302 or other communication medium.

Computing system 300 can also include a main memory 308, such as random access memory (RAM) or other dynamic memory, for storing information and instructions to be executed by processor 304. Main memory 308 also may be used for storing temporary variables or other intermediate information during execution of instructions to be executed by processor 304. Computing system 300 may likewise include a read only memory (“ROM”) or other static storage device coupled to bus 302 for storing static information and instructions for processor 304.

The computing system 300 may also include information storage system 310, which may include, for example, a media drive 312 and a removable storage interface 320. The media drive 312 may include a drive or other mechanism to support fixed or removable storage media, such as a hard disk drive, a floppy disk drive, a magnetic tape drive, an optical disk drive, a CD or DVD drive (R or RW), or other removable or fixed media drive. Storage media 318, may include, for example, a hard disk, floppy disk, magnetic tape, optical disk, CD or DVD, or other fixed or removable medium that is read by and written to by media drive 314. As these examples illustrate, the storage media 318 may include a computer-readable storage medium having stored therein particular computer software or data.

In alternative embodiments, information storage system 310 may include other similar components for allowing computer programs or other instructions or data to be loaded into computing system 300. Such components may include, for example, a removable storage unit 322 and an interface 320, such as a program cartridge and cartridge interface, a removable memory (for example, a flash memory or other removable memory module) and memory slot, and other removable storage units 322 and interfaces 320 that allow software and data to be transferred from the removable storage unit 318 to computing system 300.

Computing system 300 can also include a communications interface 324. Communications interface 324 can be used to allow software and data to be transferred between computing system 300 and external devices. Examples of communications interface 324 can include a modem, a network interface (such as an Ethernet or other NIC card), a communications port (such as for example, a USB port), a PCMCIA slot and card, etc. Software and data transferred via communications interface 324 are in the form of signals which can be electronic, electromagnetic, optical or other signals capable of being received by communications interface 324. These signals are provided to communications interface 324 via a channel 328. This channel 328 may carry signals and may be implemented using a wireless medium, wire or cable, fiber optics, or other communications medium. Some examples of a channel include a phone line, a cellular phone link, an RF link, a network interface, a local or wide area network, and other communications channels.

In this document, the terms “computer program product,” “computer-readable medium” and the like may be used generally to refer to media such as, for example, memory 308, storage device 318, or storage unit 322. These and other forms of computer-readable media may be involved in storing one or more instructions for use by processor 304, to cause the processor to perform specified operations. Such instructions, generally referred to as “computer program code” (which may be grouped in the form of computer programs or other groupings), when executed, enable the computing system 300 to perform features or functions of embodiments of the present invention. Note that the code may directly cause the processor to perform specified operations, be compiled to do so, and/or be combined with other software, hardware, and/or firmware elements (e.g., libraries for performing standard functions) to do so.

In an embodiment where the elements are implemented using software, the software may be stored in a computer-readable medium and loaded into computing system 300 using, for example, removable storage drive 314, drive 312 or communications interface 324. The control logic (in this example, software instructions or computer program code), when executed by the processor 304, causes the processor 304 to perform the functions of the invention as described herein.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Although the present invention has been described in connection with some embodiments, it is not intended to be limited to the specific form set forth herein. Rather, the scope of the present invention is limited only by the claims. Additionally, although a feature may appear to be described in connection with particular embodiments, one skilled in the art would recognize that various features of the described embodiments may be combined in accordance with the invention.

Furthermore, although individually listed, a plurality of means, elements or method steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather the feature may be equally applicable to other claim categories, as appropriate.

Moreover, it will be appreciated that various modifications and alterations may be made by those skilled in the art without departing from the spirit and scope of the invention. The invention is not to be limited by the foregoing illustrative details, but is to be defined according to the claims.

What is claimed is:

1. A computer-implemented method, in an online transaction system, for determining a reputation score for a party involved in a transaction, the method comprising:
increasing the reputation score based on consideration received from the party; and
providing the score for display on a client.

2. The method of claim 1, wherein increasing the reputation score comprises establishing an initial reputation score.

3. The method of claim 1, wherein providing the score comprises providing the score if the score satisfies a threshold condition.

4. The method of claim 1, wherein increasing the score comprises increasing the score by at least a portion of the amount of the consideration.

5. The method of claim 1, further comprising adjusting the score based upon a user rating of the transaction.

6. The method of claim 1, further comprising adjusting the score based upon the number of negative user ratings.

7. The method of claim 1, further comprising adjusting the score based upon the value of the transaction weighted by a user rating of the transaction.

8. The method of claim 1, further comprising returning to the party at least a portion of the consideration in response to a favorable event.

9. The method of claim 8, wherein reputation score is decreased based upon the amount of returned consideration.

10. The method of claim 8, wherein the event comprises the score exceeding a threshold.

11. The method of claim 8, wherein the event comprises the party receiving less than a predetermined number of negative user ratings over a period of time.

12. The method of claim 8, wherein the event comprises receiving at least a predetermined number of positive user ratings over a period of time.

13. The method of claim 1, wherein the transaction system is an auction system.

14. The method of claim 1, further comprising allowing the party to participate in transactions based upon the reputation score exceeding a predetermined threshold.

15. A computer-implemented method, in an online transaction system, for determining a reputation score for a party involved in a transaction, the method comprising:
determining the score based upon commissions made in transactions involving the party; and
providing the score for display on a client.

16. The method of claim 15, wherein determining the score is also based upon at least one attribute of the transaction selected from the group consisting of: value of the transaction; user rating of the transaction; and reputation of the user providing a rating of the transaction.

17. The method of claim 15, wherein determining the score comprises determining the score based upon (a non-decreasing function of the commissions) and (the value of transactions conducted by the party weighted by user ratings).

18. The method of claim 15, wherein determining the score comprises determining the score based upon (a non-decreasing function of commissions paid by the party as seller) and (the value of sales conducted by the party as seller weighted by user ratings).

19. The method of claim 15, wherein determining the score comprises determining the score based upon (a non-decreasing function of commissions paid by the party as seller) and (the value of transactions conducted by the party that received negative user ratings).

20. The method of claim 19, wherein determining the score is further based upon the total number of transactions by the party.

21. The method of claim 15, wherein providing the score comprises providing the score if the score satisfies a threshold condition.

22. The method of claim 15, wherein determining the score is also based upon a number of negative user ratings.

23. The method of claim 15, wherein the transactional system is an auction system.

24. The method of claim 15, further comprising increasing the score based on consideration received from the party.

25. The method of claim 24, further comprising decreasing the score by the at least a portion of the consideration in response to a negative rating of the transaction.

26. The method of claim 24, further comprising refunding at least a portion of the consideration in response to a favorable event.

27. A computer-implemented method, in an online activity, for determining a reputation score for a party involved in the online activity, the method comprising:
increasing the reputation score based on consideration received from the party;
allowing the party to participate in the activity based upon the reputation score; and
returning to the party at least a portion of the consideration in response to a favorable event.

28. The method of claim 27, wherein the event comprises the score exceeding a threshold.

29. The method of claim 27, wherein the event comprises the party receiving less than a predetermined number of negative user ratings over a period of time.

30. The method of claim 27, wherein the event comprises receiving at least a predetermined number of positive user ratings over a period of time.

31. The method of claim 27, wherein increasing the reputation score comprises establishing an initial reputation score.

32. The method of claim 27, wherein allowing participation is conditioned upon the score satisfying a threshold condition.

33. The method of claim 27, further comprising adjusting the score based upon a user rating of the party's participation in the activity.

34. The method of claim 27, further comprising decreasing the score by the at least a portion of the consideration weighted by a user rating of the party's participation in the network.

35. The method of claim 27, wherein the online activity is an online social network.

36. An apparatus, in an online transaction system, for determining a reputation score for a party involved in a transaction, the apparatus comprising:
logic for increasing the reputation score based on consideration received from the party; and
logic for providing the score for display on a client.

37. The apparatus of claim 36, wherein increasing the reputation score comprises establishing an initial reputation score.

38. The apparatus of claim 36, wherein providing the score comprises providing the score if the score satisfies a threshold condition.

39. The apparatus of claim 36, wherein increasing the score comprises increasing the score by at least a portion of the amount of the consideration.

40. The apparatus of claim 36, further comprising logic for adjusting the score based upon a user rating of the transaction.

41. The apparatus of claim 36, further comprising logic for adjusting the score based upon the value of the transaction weighted by a user rating of the transaction.

42. The apparatus of claim 36, further comprising logic for returning to the party at least a portion of the consideration in response to a favorable event.

43. The apparatus of claim 36, wherein the transaction system is an auction system.

44. The apparatus of claim 36, further comprising logic for allowing the party to participate in transactions based upon the reputation score exceeding a predetermined threshold.

45. An apparatus, in an online transaction system, for determining a reputation score for a party involved in a transaction, the apparatus comprising:
logic for determining the score based upon commissions made in transactions involving the party; and
logic for providing the score for display on a client.

46. The apparatus of claim 45, wherein determining the score is also based upon at least one attribute of the transaction selected from the group consisting of: value of the transaction; user rating of the transaction; and reputation of the user providing a rating of the transaction.

47. The apparatus of claim 45, wherein determining the score comprises determining the score based upon (a non-decreasing function of the commissions) and (the value of transactions conducted by the party weighted by user ratings).

48. The apparatus of claim 45, wherein the transactional system is an auction system.

49. An apparatus for determining a reputation score for a party involved in an online activity, the apparatus comprising:
logic for increasing the reputation score based on consideration received from the party;
logic for allowing the party to participate in the activity based upon the reputation score; and
logic for returning to the party at least a portion of the consideration in response to a favorable event.

50. The apparatus of claim 49, wherein the event comprises the score exceeding a threshold.

51. The apparatus of claim 49, wherein the event comprises the party receiving less than a predetermined number of negative user ratings over a period of time.

52. The apparatus of claim 49, wherein the event comprises receiving at least a predetermined number of positive user ratings over a period of time.

53. The apparatus of claim 49, wherein increasing the reputation score comprises establishing an initial reputation score.

54. The apparatus of claim 49, wherein allowing participation is conditioned upon the score satisfying a threshold condition.

55. The apparatus of claim 49, further comprising logic for adjusting the score based upon a user rating of the party's participation in the activity.

56. The apparatus of claim 49, wherein the online activity is an online social network.

57. A computer-readable medium comprising instructions for determining a reputation score for a party involved in a transaction in an online transaction system, the instructions for:
increasing the reputation score based on consideration received from the party; and
providing the score for display on a client.

58. The computer-readable medium of claim 57, wherein increasing the reputation score comprises establishing an initial reputation score.

59. The computer-readable medium of claim 57, wherein providing the score comprises providing the score if the score satisfies a threshold condition.

60. The computer-readable medium of claim 57, wherein increasing the score comprises increasing the score by at least a portion of the consideration.

61. The computer-readable medium of claim 57, further comprising instructions for adjusting the score based upon a user rating of the transaction.

62. The computer-readable medium of claim 57, further comprising instructions for adjusting the score based upon the number of negative user ratings.

63. The computer-readable medium of claim 57, further comprising instructions for adjusting the score based upon the value of the transaction weighted by a user rating of the transaction.

64. The computer-readable medium of claim 57, further comprising instructions for returning to the party at least a portion of the consideration in response to a favorable event.

65. The computer-readable medium of claim 64, further comprising instructions for decreasing reputation score based upon the amount of returned consideration.

66. The computer-readable medium of claim 64, wherein the event comprises the score exceeding a threshold.

67. The computer-readable medium of claim 64, wherein the event comprises the party receiving less than a predetermined number of negative user ratings over a period of time.

68. The computer-readable medium of claim 64, wherein the event comprises receiving at least a predetermined number of positive user ratings over a period of time.

69. The computer-readable medium of claim 57, wherein the transaction system is an auction system.

70. The computer-readable medium of claim 57, further comprising instructions for allowing the party to participate in transactions based upon the reputation score exceeding a predetermined threshold.

71. A computer-readable medium comprising instructions for determining a reputation score for a party involved in a transaction in an online transaction system, the instructions for:
determining the score based upon commissions made in transactions involving the party; and
providing the score for display on a client.

72. The computer-readable medium of claim 71, wherein determining the score is based upon at least one attribute selected from the group consisting of: value of the transaction; user rating of the transaction; and reputation of the user providing a rating of the transaction.

73. The computer-readable medium of claim 71, wherein determining the score comprises determining the score based upon (a non-decreasing function of the commissions) and (the value of transactions conducted by the party weighted by user ratings).

74. The computer-readable medium of claim 71, wherein determining the score comprises determining the score based upon (a non-decreasing function of commissions paid by the party as seller) and (the value of sales conducted by the party as seller weighted by user ratings).

75. The computer-readable medium of claim 71, wherein determining the score comprises determining the score based upon (a non-decreasing function of commissions paid by the party as seller) and (the value of transactions conducted by the party that received negative user ratings).

76. The computer-readable medium of claim 75, wherein determining the score is further based upon the total number of transactions by the party.

77. The computer-readable medium of claim 71, wherein providing the score comprises providing the score if the score satisfies a threshold condition.

78. The computer-readable medium of claim 71, wherein determining the score is also based upon a number of negative user ratings.

79. The computer-readable medium of claim 71, wherein the transaction system is an auction system.

80. The computer-readable medium of claim 71, further comprising instructions for increasing the score based on consideration received from the party.

81. The computer-readable medium of claim 80, further comprising instructions for decreasing the score by the at least a portion of the consideration in response to a negative rating of the transaction.

82. The computer-readable medium of claim 80, further comprising instructions for refunding at least a portion of the consideration in response to a favorable event.

83. A computer-readable medium comprising instructions for determining a reputation score for a party involved in an online activity, the instructions for:
increasing the reputation score based on consideration received from the party;
allowing the party to participate in the activity based upon the reputation score; and
returning to the party at least a portion of the consideration in response to a favorable event.

84. The computer-readable medium of claim 83, wherein the event comprises the score exceeding a threshold.

85. The computer-readable medium of claim 83, wherein the event comprises the party receiving less than a predetermined number of negative user ratings over a period of time.

86. The computer-readable medium of claim 83, wherein the event comprises receiving at least a predetermined number of positive user ratings over a period of time.

87. The computer-readable medium of claim 83, wherein increasing the reputation score comprises establishing an initial reputation score.

88. The computer-readable medium of claim 83, wherein allowing participation is conditioned upon the score satisfying a threshold condition.

89. The computer-readable medium of claim 83, further comprising instructions for adjusting the score based upon a user rating of the party's participation in the activity.

90. The computer-readable medium of claim 83, wherein the online activity is an online social network.
